(19) United States
(12) Patent Application Publication
(10) Pub. No.: US 2016/0119958 A1
(43) Pub. Date: Apr. 28, 2016

(54) RANDOM ACCESS CHANNEL WITH A GRID OF BEAMS FOR COMMUNICATION SYSTEMS

(71) Applicant: NOKIA SOLUTIONS AND NETWORKS OY, Espoo (FI)

(72) Inventors: Jun TAN, Lake Zurich, IL (US); Mark CUDAK, Rolling Meadows, IL (US); Timothy THOMAS, Palatine, IL (US); Rapeepat RATASUK, Hoffman Estates, IL (US); Frederick VOOK, Schaumburg, IL (US); Amitabha GHOSH, Buffalo Grove, IL (US); Anup TALUKDAR, Schaumburg, IL (US)

(21) Appl. No.: 14/524,726

(22) Filed: Oct. 27, 2014

(51) Int. Cl. H04W 74/08; H04B 7/06; H04W 74/00; H04B 7/04

(52) U.S. Cl. CPC H04W 74/0891; H04B 7/0408; H04B 7/0617; H04W 74/006

(57) ABSTRACT

Systems, methods, apparatuses, and computer program products for random access channel (RACH) with a grid of beams for communication systems are provided. One method includes transmitting, by a base station, a beacon signal in one time slot with multiple switched beams, wherein the beams cover an intended coverage area with a grid-of-beams in both horizontal and vertical directions. The method may also comprise switching receiving beams in the grid-of-beams at a network reserved random access channel (RACH) slot by following an identical or directly related beam switching pattern in a downlink (DL) beacon channel. Another method includes detecting, by a user equipment, a beam ID in the downlink beacon channel, selecting the RACH slot using the detected beam ID, and transmitting, by the user equipment, a random access channel (RACH) signature in one or multiple beam blocks within a random access channel (RACH) slot.

### FIELD

Embodiments of the invention generally relate to wireless communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A) and/or future 5G radio access technology. In particular, some embodiments may relate to random access channel (RACH) design for communication systems.

### BACKGROUND

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and most of the RNC functionalities are contained in the enhanced Node B (eNodeB or eNB).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-11, LTE Rel-12, LTE Rel-13, LTE Rel-14) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while keeping the backward compatibility. One of the key features of LTE-A is carrier aggregation, which allows for increasing the data rates through aggregation of two or more LTE carriers.

Furthermore, a global bandwidth shortage facing wireless carriers has motivated the consideration of the underutilized millimeter wave (mmWave) frequency spectrum for future broadband cellular communication networks. mmWave (or extremely high frequency) generally refers to the frequency range between 30 and 300 gigahertz (GHz). This is the highest radio frequency band in practical use today. Radio waves in this band have wavelengths from ten to one millimeter, giving it the name millimeter band or millimeter wave.

The amount of wireless data might increase one thousand fold over the next ten years. Essential elements in solving this challenge include obtaining more spectrum, having smaller cell sizes, and using improved technologies enabling more bits/s/Hz. An important element in obtaining more spectrum is to move to higher frequencies, above 6 GHz. For fifth generation wireless systems (5G), an access architecture for deployment of cellular radio equipment employing mmWave radio spectrum has been proposed. In addition to extending cellular service into the mmWave band, dynamic spectrum access is an important technique to improve spectrum utilization.

### SUMMARY

One embodiment is directed to a method that may include transmitting, by a base station, at least one beacon signal in one time slot with multiple switched beams, where the beams cover an intended coverage area with a grid-of-beams in both horizontal and vertical directions. The method may also include switching receiving beams in the grid-of-beams at a network reserved random access channel (RACH) slot by following an identical or directly related beam switching pattern in a downlink (DL) beacon channel.

According to an embodiment, the method may further include detecting random access channel (RACH) requests and related beam ID in one beam block within the random access channel (RACH) slot. In certain embodiments, the method may also include coordinating random access channel (RACH) reception across two arrays with orthogonal polarizations. In one embodiment, the at least one beacon signal may include a synchronization signal for user equipment synchronization.

Another embodiment is directed to an apparatus including at least one processor and at least one memory including computer program code. The at least one memory and computer program code may be configured, with the at least one processor, to cause the apparatus at least to transmit a least one beacon signal in one time slot with multiple switched beams, where the beams cover an intended coverage area with a grid-of-beams in both horizontal and vertical directions. The apparatus may be configured to perform reception by switching receiving beams in the grid-of-beams at a network reserved random access channel (RACH) slot by following an identical or directly related beam switching pattern in a downlink (DL) beacon channel.

According to an embodiment, the at least one memory and the computer program code may be further configured, with the at least one processor, to cause the apparatus at least to detect random access channel (RACH) requests and related beam ID in one beam block within the random access channel (RACH) slot. In one embodiment, the at least one memory and the computer program code may be further configured, with the at least one processor, to cause the apparatus at least to coordinate random access channel (RACH) reception across two arrays with orthogonal polarizations. The at least one beacon signal may include a synchronization signal for user equipment synchronization.

Another embodiment is directed to a computer program, embodied on a non-transitory computer readable medium. The computer program may be configured to control a processor to perform a process. The process may include transmitting, by a base station, at least one beacon signal in one time slot with multiple switched beams, where the beams cover an intended coverage area with a grid-of-beams in both horizontal and vertical directions. The process may also include switching receiving beams in the grid-of-beams at a network reserved random access channel (RACH) slot by following an identical or directly related beam switching pattern in a downlink (DL) beacon channel.

Another embodiment is directed to a method that may include detecting, by a user equipment, a beam ID in the downlink beacon channel, selecting a random access channel (RACH) slot using the detected beam ID, and transmitting a random access channel (RACH) signature in one or multiple beam blocks within the random access channel (RACH) slot.

In an embodiment, the detected beam ID may include a beam ID of a strongest detected beam. According to certain embodiments, the beam ID may be implicitly provided by being associated with a transmission slot. In other embodiments, the beam ID may be explicitly provided by being contained in a beacon sequence. According to one embodiment, the transmitting may include transmitting the random access channel (RACH) signature with a transmit beam related to the detected beam ID.

Another embodiment is directed to an apparatus including at least one processor and at least one memory including computer program code. The at least one memory and computer program code may be configured, with the at least one processor, to cause the apparatus at least to detect a beam ID in the downlink beacon channel, select a random access channel (RACH) slot using the detected beam ID, and transmit a random access channel (RACH) signature in one or multiple beam blocks within the random access channel (RACH) slot.

In an embodiment, the detected beam ID may include a beam ID of a strongest detected beam. According to certain embodiments, the beam ID may be implicitly provided by being associated with a transmission slot. In other embodiments, the beam ID may be explicitly provided by being contained in a beacon sequence. According to one embodiment, the at least one memory and the computer program code may be further configured, with the at least one processor, to cause the apparatus at least to transmit the random access channel (RACH) signature with a transmit beam related to the detected beam ID.

Another embodiment is directed to a computer program, embodied on a non-transitory computer readable medium. The computer program may be configured to control a processor to perform a process. The process may include detecting, by a user equipment, a beam ID in the downlink beacon channel, selecting a random access channel (RACH) slot using the detected beam ID, and transmitting a random access channel (RACH) signature in one or multiple beam blocks within the random access channel (RACH) slot.

### BRIEF DESCRIPTION OF THE DRAWINGS

For proper understanding of the invention, reference should be made to the accompanying drawings, wherein:

FIG. 1 illustrates a common single Tx/Rx chain with RF beamforming;

FIG. 2 illustrates an example 4×4 antenna design at a base station with all co-polarized elements, according to an embodiment;

FIG. 3 illustrates one example of the grid of beams in 2-D space, according to an embodiment;

FIG. 4 illustrates an example of the timing structure of the downlink (DL) beacon, according to an embodiment;

FIG. 5 illustrates an example for the uplink (UL) RACH slot structure with multiple beam blocks, according to an embodiment;

FIG. 6 illustrates an example signaling diagram of the RACH process with a grid-of-beams, according to an embodiment;

FIG. 7 illustrates a base station architecture having multiple arrays covering the same geographic area, but with orthogonal polarizations to each other, according to one embodiment;

FIG. 8a illustrates a block diagram of an apparatus, according to one embodiment;

FIG. 8b illustrates a block diagram of an apparatus, according to another embodiment;

FIG. 9a illustrates a flow diagram of a method, according to one embodiment; and

FIG. 9b illustrates a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for random access channel (RACH) with a grid of beams for communication systems, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Embodiments of the invention relate to wireless communications (e.g., 5G) and, in particular, to RACH design for millimeter wave (mmWave) communication systems, where omni-direction transmissions may suffer high path loss due to mmWave propagation. In order to overcome this issue, an embodiment provides a RACH mechanism using a grid of beams to increase the beamforming gain. According to one embodiment, a base station may transmit a downlink (DL) beacon (or reference signal) in one time slot for each beam when multiple switched beams are used. A user equipment (UE) receiving the beacon may transmit its RACH message at a specific time interval based on the best received beacon. The base station, once it has received all RACH messages, may then provide uplink grants to the UEs.

As suggested above, embodiments of the invention relate to the physical layer of communication systems and, more specifically, to RACH design for wireless communication systems. The RACH may be used by a mobile station for an unscheduled uplink transmission to request network access to a base station.

As discussed briefly above, a problem arises in RACH design for mmWave communication system, where traditional omni-direction transmission will suffer high path loss with mmWave propagation. It is possible to incorporate arrays of transmitter/receiver (Tx/Rx) antenna elements at both base stations and mobile stations (e.g., UEs) to provide potential beamforming gain to support sufficient coverage at mmWave bands. To support beamformed RACH, both base stations and mobile stations should have knowledge of related beams to provide reliable RACH performance over a coverage area.

More specifically, mmWave communication systems have a higher path loss relative to lower frequencies which must be overcome to provide reliable link coverage. To ensure proper coverage, arrays of Tx/Rx antenna elements are usually applied to provide beamforming gain for mmWave communication links. For data transmission or reception, the beamformed transmission requires knowledge of beam direction at both the Tx and Rx points. The difficulty with the RACH is that the access point will not know when or which mobile station is sending a RACH message so it cannot apply the best receive beam for that user. For a wireless network, a base station of the network usually has limited knowledge on initial location of one mobile station. When the mobile station needs to send a RACH request, the traditional approach, such as in LTE, is to send the RACH in omni-direction, and the base station then listens in omni-direction for potential RACH requests in the coverage area. Because there is no beamforming gain due to the omni-direction property of Tx/Rx, the RACH signal would need to be long enough to provide enough energy for reliable detection at the base station. However, the increased signal length could be a problem in real deployments since phase noise will cause the received signal that are very long in time to have a random phase which hurts coherent combining of those signals.

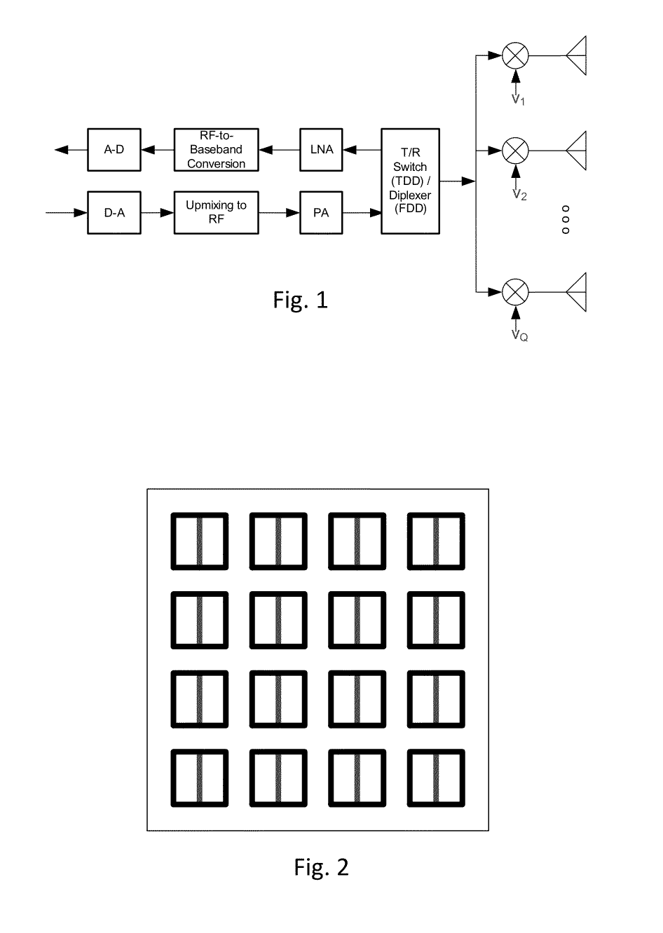

For mmWave communication systems, the beamforming processing is usually applied in radio frequency (RF) domain because of the wide bandwidth's limitation on A/D and D/A converters. In other words with the high bandwidths expected at mmWave, the analog-to-digital (A/D) and digital-to-analog (D/A) converters consume a large amount of power and hence the number of A/D and D/A converters should be minimized. A common single Tx/Rx chain with RF beamforming is illustrated in FIG. 1. Beamforming is achieved through the control of phase weights vᵢ in analog domain at RF. When only beamfomed transmission/reception is supported for mmWave systems, the RACH design must support the system with both DL/UL RF beamformed transmission.

Therefore, according to embodiments of the invention, a RACH design is provided to support mmWave wireless networks. In particular, an embodiment provides a RACH design with beamformed transmission/reception based on a “grid-of-beams”.

In an embodiment of the invention, the mobile station may send its RACH message at a specific time interval as determined from a best beam chosen from a beacon interval. The beams may be coordinated at the access point across two arrays with a similar structure, but with orthogonal polarizations.

Thus, embodiments of the invention provide a design of RACH based on a “grid of beams” at the base station array. The RACH design may be suitable for mmWave communication systems where base stations utilize an array of Tx/Rx antenna elements, for example.

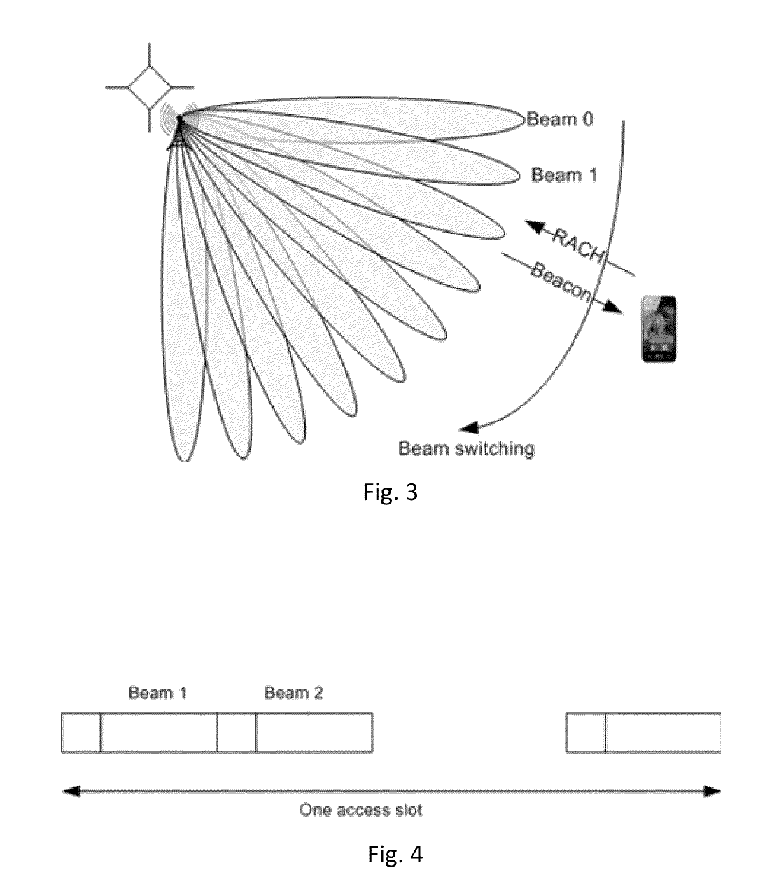

According to one embodiment, a base station may transmit a DL beacon or reference signal in one time slot with multiple switched beams. The same beacon signal may be used for each beam or multiple beacon signals may be used where, for example, each beam has its own unique beacon signal. The beams cover the intended coverage area with a “grid of beams” in both horizontal and vertical directions. For an M×M antenna array at the base station, the beams will be 3-dimenstional. FIG. 2 illustrates an example 4×4 antenna design at a base station with all co-polarized elements. Each beam in the “grid-of-beams” may cover a narrow area in both vertical and horizontal direction.

The beacon signal can be a synchronization signal for UE (e.g., mobile or mobile station) synchronization where a beam ID may also be included in each beam or implicitly provided based on the transmission flow. FIG. 3 illustrates one example of the grid of beams in 2-D space.

The beacon signals transmitted from each beam may be in one time slot, where each beam transmits in one block within the time slot. An example of the detailed timing structure of the DL beacon is illustrated in FIG. 4. The DL beam switching pattern may be cell specific and may be determined by cell planning. Each transmission from a beam may include two portions as shown, one part (e.g., the first part) may contain pilot symbols and the second part may contain broadcast control information. Alternatively, the first part may be a short guard period which enables the switching of RF beams and the second part may be the beacon.

The RACH may use one uplink (UL) time slot reserved by the network. During the RACH slot, the base station may follow the identical DL beacon beam-switching pattern to form a Rx grid-of-beam. Each Rx beam has its corresponding beam in the DL beacon channel. The base station may use the RACH grid-of-beam to detect RACH signatures from UEs.

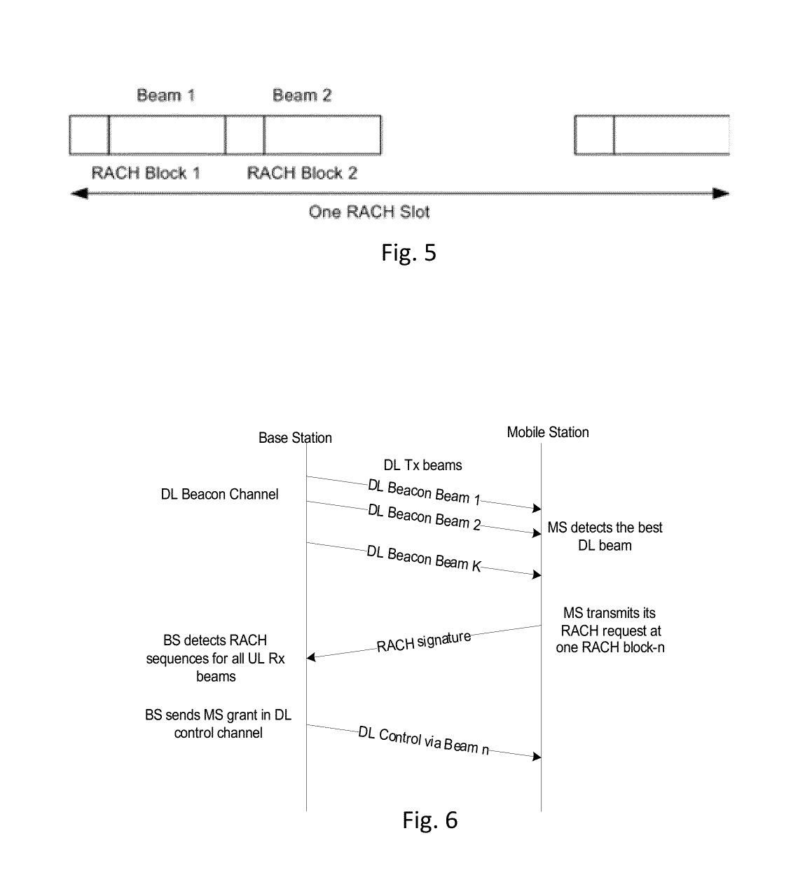

At the UE side, during the initial cell search or synchronization process, a UE may detect one beacon beam in the beacon slot. The detected beacon beam provides network timing and the optimal DL beam. When a RACH request is provided by the UE upper layer, the UE may transmit its RACH signature sequence in the RACH slot associated with the optimal beam. One example for the UL RACH slot structure with multiple beam blocks is illustrated in FIG. 5.

For example, if Beam 2 is detected by one UE as its best DL beacon channel, the UE transmits its RACH request at RACH Block 2. In addition, the UL RACH transmission can be also Tx beamformed, depending on UE's Tx antenna array. The direction of the Tx beam may be determined by the DL beam detected from the DL beacon channel. For example, the UE may try different Rx beams for a given DL beam (e.g., over multiple frames when the DL beacon on the beam is repeated) and the best Rx beam would be the same weights to use on the Tx side (i.e., the same direction) when transmitting the RACH message. There are a few ways the UE could know when to transmit its RACH message. One method is that, when it detects its best beam, the beacon message includes an indication of the beam number. This beam number will correspond to a specific time instance to transmit the RACH message. Alternatively, the time to send the RACH message could be implicit such as a fixed time interval after the reception of the best DL beacon signal.

As another alternative, the UE can transmit the RACH signature on multiple RACH blocks or all RACH blocks shown in FIG. 5. The same RACH signature sequence can be repeated over multiple RACH blocks providing additional opportunities for the base station to detect the RACH form the UE. For example, the UE may transmit its RACH on the best M_{B} beams that it detects from the beacons sent on each beam.

The base station may detect all possible RACH signature sequences for all RACH blocks. At one RACH block, one beam out of the grid-of-beam is formed as one UL Rx beam by the base station. The base station can detect UE RACH requests in the coverage of one beam at each RACH block.

It is noted that a RACH collision happens when 1) at least two UE transmit their RACH signatures in the same RACH blocks; and 2) the UEs select the identical RACH signature.

A UE randomly selects RACH signatures out of a set of RACH sequence for RACH request. A greater size of RACH sequence set will reduce the collision probability significantly.

FIG. 6 illustrates an example signaling diagram of the RACH process with a grid-of-beams, according to an embodiment. In this embodiment, the DL beacon channel transmits beamformed synchronization sequence over multiple beams. Each beam block within the DL beacon slot has one beam among the “grid-of-beams”. A UE in the network may detect one DL beam with the largest signal-to-noise ratio (SNR). The beam ID, related with the location of the beam block within the beacon slot, may also be detected. The UE may transmit its RACH request in either one or multiple beam blocks in the system reserved RACH slot, with a Tx beam associated with the detected DL beam. The Tx beam at the UE may be based directly on the preferred DL beam. In other words, the UE's Tx beam may be determined by trying different Rx beams for a given DL beacon (e.g., over multiple frames when the DL beacon on the beam is repeated) and the best Rx beam would be the same weights to use on the Tx side. At the RACH slot, the received beams may be formed at the base station following identical or related beam switching pattern in DL beacon channel. At a beam block, the base station may detect RACH requests associated with the single beam in the corresponding direction. After the RACH requests are detected, the base station will send a corresponding RACH ACK (acknowledgement) or UL grant message via DL control channel, depending on network scheduling schemes.

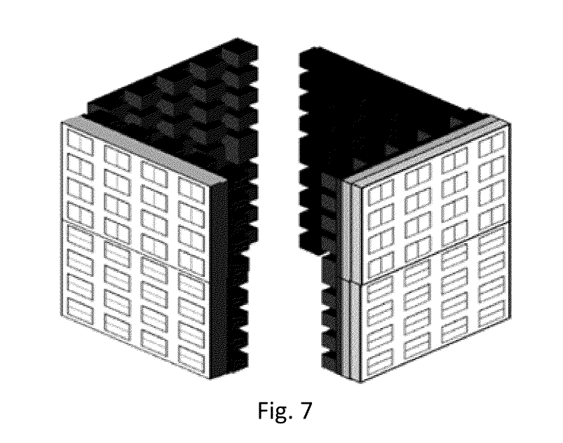

Complicating the RACH process is when the base station has multiple arrays covering the same geographic area, but with orthogonal polarizations to each other. An example of this architecture is illustrated in FIG. 7, where each sector has two 4×4 arrays, and each with orthogonal polarizations relative to each other (e.g., the top array is vertically polarized and the bottom array is horizontally polarized). Each array has its own separate RF beamformer as illustrated in FIG. 1 (i.e., there will be two transceivers per sector where each transceiver will feed one of the two arrays). This base station configuration provides robustness to random polarizations at the UE and also enables multiple spatial streams to be sent to a UE through the orthogonal polarizations.

There are at least the following two options for handling this array architecture:
1. Treat the two M×M arrays per sector as one larger array with 2M² elements. In this case, the above procedures all work but with the number of beams being designed for 2M² elements instead of M² elements. The results, however, will mean that the number of needed beams will be increased over the single-polarized array; more resources in time are needed on the beacon channel as well as for the RACH reception. For example, a rule of thumb is that the grid of beams needs 2M beams for each dimensions meaning a M×M array needs 4M² beams in the grid of beams. When adding the polarization dimension (which has two more dimensions), following a similar rule of thumb means that 4 times 4M² or 16M² beams are needed.
2. As illustrated in FIG. 7, the two arrays will most likely have the same structure but with different polarizations. For example, the antennas could be spaced by half a wavelength in both vertical and horizontal directions meaning that the beam patterns generated from each array will be the same (or very similar) when using the same RF array on each array. In this case, the two arrays could transmit the same beacon signal from the same RF beam during one of the time instances of the beacon channel. Then, the UE picks the strongest beacon signal to transmit its own RACH and to decide how to choose the RF beam for its own transmissions. In this way (following the rule of thumb stated in item 1 above), instead of needing 16M² time instances for the beacon and RACH intervals, only 4M² time instances are needed. Since each of the two arrays may have an unknown phase relative to each other, the base station may want to alternate the phase on one of the arrays when it transmits and receives on the beams. For example, on a first beacon interval and subsequent RACH interval, the arrays send the same beacons and receive the same RACH messages from the same set of beams. On the next beacon interval and subsequent RACH interval, one array sends the negative of the beacon sequence and receives with negative of the beam during the RACH interval. In this manner, the UE may prefer either the first beacon and RACH intervals or the second beacon and RACH intervals.

Another complication in the RACH process may be where the UE also has a dual array structure similar to the structure in FIG. 7. When the UE transmits the RACH with the two beams (one from the horizontally-polarized array, one from the vertically-polarized array), there are two options. The first option is the UE co-phases the two arrays where the optimal co-phasing information is determined based on the signals received during the downlink beacon intervals. The second option is for a UE with this dual array structure to use a space-time coding technique (e.g., the Alamouti 2-antenna space-time code as known in the art) to encode the RACH data across the two beams.

Some signatures may also be reserved to send specific messages using the RACH preamble. A certain subset of all RACH sequences may be reserved to indicate special events to the access points, or to indicate special control information. For example, if a UE was blocked from accessing an access point, it can send one reserved signature to indicate that this was a handoff event.

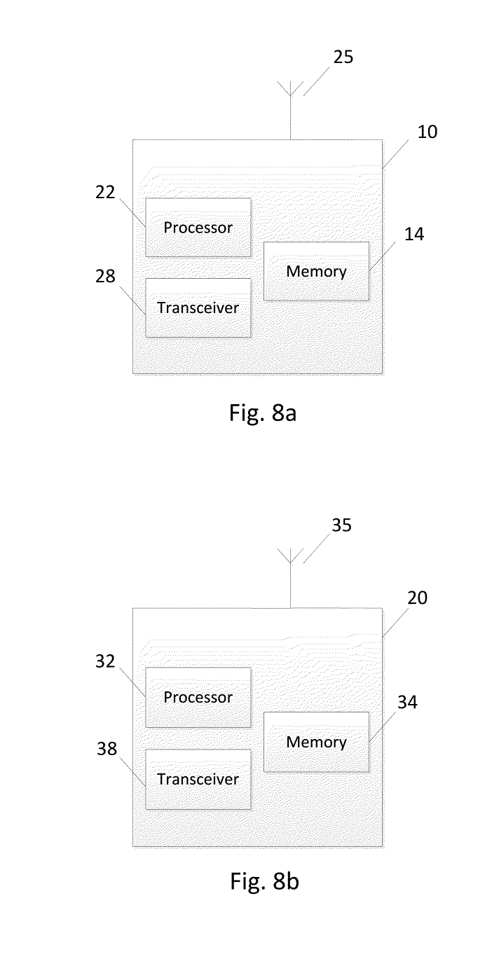

FIG. 8a illustrates an example of an apparatus 10 according to an embodiment. In an embodiment, apparatus 10 may be a node, host, or server in a communications network or serving such a network, such as an access point or base station. It should be noted that one of ordinary skill in the art would understand that apparatus 10 may include components or features not shown in FIG. 8a.

As illustrated in FIG. 8a, apparatus 10 includes a processor 22 for processing information and executing instructions or operations. Processor 22 may be any type of general or specific purpose processor. While a single processor 22 is shown in FIG. 8a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In one embodiment, apparatus 10 may be an access point or base station, for example. In this embodiment, apparatus 10 may be controlled by memory 14 and processor 22 to transmit a beacon signal in one time slot with multiple switched beams, where the beams cover an intended coverage area with a grid-of-beams in both horizontal and vertical directions. In particular, in one embodiment, apparatus 10 may be controlled to switch receiving beams in the grid-of-beams at a network reserved random access channel (RACH) slot by following an identical or directly related beam switching pattern in a downlink (DL) beacon channel.

In certain embodiments, apparatus 10 may be controlled by memory 14 and processor 22 to detect random access channel (RACH) requests and a related beam ID in one beam block within the random access channel (RACH) slot. Apparatus 10 may also be controlled by memory 14 and processor 22 to coordinate random access channel (RACH) reception across two arrays with orthogonal polarizations. According to an embodiment, the beacon signal may be a synchronization signal for user equipment synchronization.

FIG. 8b illustrates an example of an apparatus 20 according to another embodiment. In an embodiment, apparatus 20 may be a node or element in a communications network or associated with such a network, such as mobile device, mobile unit, or UE. It should be noted that one of ordinary skill in the art would understand that apparatus 20 may include components or features not shown in FIG. 8b.

As illustrated in FIG. 8b, apparatus 20 includes a processor 32 for processing information and executing instructions or operations. Processor 32 may be any type of general or specific purpose processor. While a single processor 32 is shown in FIG. 8b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a mobile unit or mobile device, such as UE in LTE or LTE-A. In this embodiment, apparatus 20 may be controlled by memory 34 and processor 32 to transmit a random access channel (RACH) signature in one or multiple beam blocks within a random access channel (RACH) slot following a detected beam ID in a downlink beacon channel. In an embodiment, apparatus 20 may then be controlled by memory 34 and processor 32 to use the detected beam ID to select the random access channel (RACH) slot. The detected beam ID may be a beam ID of the strongest detected beam.

According to certain embodiments, the beam ID may be implicitly provided by being associated with a transmission slot. In other embodiments, the beam ID may be explicitly provided by being contained in a beacon sequence.

In one embodiment, apparatus 20 may be controlled by memory 34 and processor 32 to transmit the random access channel (RACH) signature with a transmit beam related to the detected beam ID.

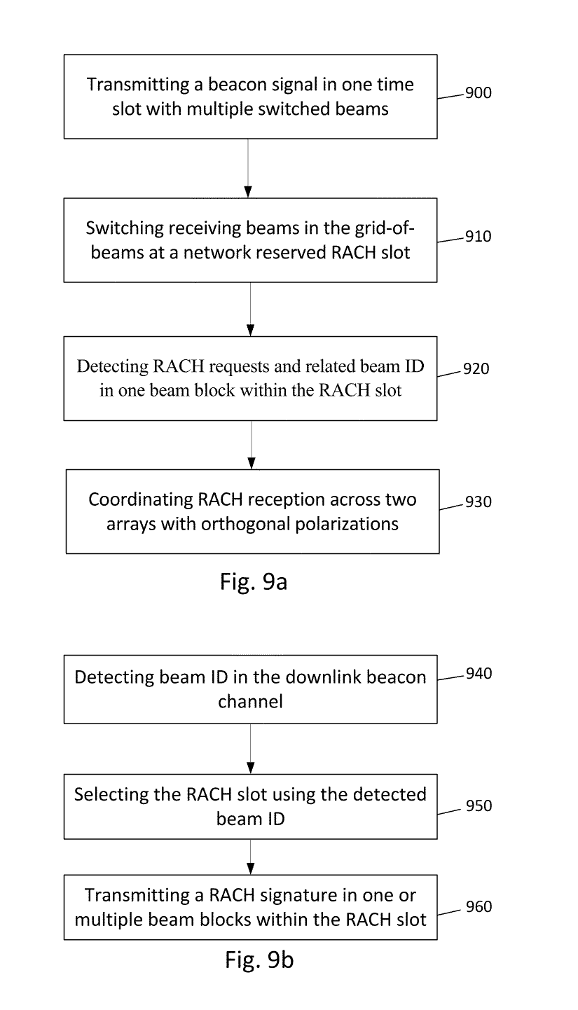

FIG. 9a illustrates a flow diagram of a method, according to one embodiment. In one embodiment, the method of FIG. 9a may be performed by a base station, for example. As illustrated in FIG. 9a, the method may include, at 900, transmitting a beacon signal in one time slot with multiple switched beams. The beams may cover an intended coverage area with a grid-of-beams in both horizontal and vertical directions. The transmission of the beacon signals may also include coordination across two arrays with orthogonal polarization. The transmitting interval may be followed by, at 910, switching receiving beams in the grid-of-beams at a network reserved random access channel (RACH) slot by following an identical or directly related beam switching pattern in a downlink (DL) beacon channel (i.e., the pattern used in the transmission step 900).

In an embodiment, the method may also include, at 920, detecting random access channel (RACH) requests and related beam ID in one beam block within the random access channel (RACH) slot. According to one embodiment, the method may further include, at 930, coordinating random access channel (RACH) reception across two arrays with orthogonal polarizations. The beacon signal may comprise, for instance, a synchronization signal for user equipment synchronization.

FIG. 9b illustrates a flow diagram of a method, according to another embodiment. In one embodiment, the method of FIG. 9b may be performed by a mobile device or UE, for example. The method may include, at 940, detecting beam ID in the downlink beacon channel. In an embodiment, the method may also include, at 950, selecting the RACH slot using the detected beam ID. In an embodiment, the detected beam ID comprises a beam ID of a strongest detected beam. The method may further include, at 960, transmitting a RACH signature in one or multiple beam blocks within the RACH slot.

According to certain embodiments, the beam ID may be implicitly provided by being associated with a transmission slot. In other embodiments, the beam ID may be explicitly provided by being contained in a beacon sequence.

In some embodiments, the functionality of any of the methods described herein, such as those illustrated in FIGS. 9a and 9b discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

Embodiments of the invention provide several advantages. For example, the RACH design with a grid of beams, according to an embodiment, utilizes beamformed transmission/receiving thus achieving a near-optimal beamforming gain for RACH transmission. In addition, there is no need to require wide-area transmission in both DL/UL which would entail a very long time interval since all transmission is based on a beamformed transmission. The coherent combining of a very long signal in time could be degraded in the presence of strong phase noise which is expected at mmWave.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
transmitting, by a base station, at least one beacon signal in one time slot with multiple switched beams, wherein the beams cover an intended coverage area with a grid-of-beams in both horizontal and vertical directions,
switching receiving beams in the grid-of-beams at a network reserved random access channel (RACH) slot by following an identical or directly related beam switching pattern in a downlink (DL) beacon channel.

2. The method according to claim 1, further comprising detecting random access channel (RACH) requests and related beam ID in one beam block within the random access channel (RACH) slot.

3. The method according to claim 1, further comprising coordinating random access channel (RACH) reception across two arrays with orthogonal polarizations.

4. The method according to claim 1, wherein the at least one beacon signal comprises a synchronization signal for user equipment synchronization.

5. An apparatus, comprising:
at least one processor; and
at least one memory including computer program code,
the at least one memory and computer program code configured, with the at least one processor, to cause the apparatus at least to
transmit a least one beacon signal in one time slot with multiple switched beams, wherein the beams cover an intended coverage area with a grid-of-beams in both horizontal and vertical directions,
wherein the apparatus is configured to perform reception by switching receiving beams in the grid-of-beams at a network reserved random access channel (RACH) slot by following an identical or directly related beam switching pattern in a downlink (DL) beacon channel.

6. The apparatus according to claim 5, wherein the at least one memory and the computer program code are further configured, with the at least one processor, to cause the apparatus at least to detect random access channel (RACH) requests and related beam ID in one beam block within the random access channel (RACH) slot.

7. The apparatus according to claim 5, wherein the at least one memory and the computer program code are further configured, with the at least one processor, to cause the apparatus at least to coordinate random access channel (RACH) reception across two arrays with orthogonal polarizations.

8. The apparatus according to claim 5, wherein the at least one beacon signal comprises a synchronization signal for user equipment synchronization.

9. The apparatus according to claim 5, wherein the apparatus comprises a base station.

10. A computer program, embodied on a non-transitory computer readable medium, the computer program configured to control a processor to perform a process, comprising:
transmitting, by a base station, at least one beacon signal in one time slot with multiple switched beams, wherein the beams cover an intended coverage area with a grid-of-beams in both horizontal and vertical directions,
switching receiving beams in the grid-of-beams at a network reserved random access channel (RACH) slot by following an identical or directly related beam switching pattern in a downlink (DL) beacon channel.

11. A method, comprising:
detecting, by a user equipment, a beam ID in the downlink beacon channel;
selecting a random access channel (RACH) slot using the detected beam ID; and
transmitting, by the user equipment, a random access channel (RACH) signature in one or multiple beam blocks within the random access channel (RACH) slot.

12. The method according to claim 11, wherein the detected beam ID comprises a beam ID of a strongest detected beam.

13. The method according to claim 11, wherein the beam ID is implicitly provided by being associated with a transmission slot.

14. The method according to claim 11, wherein the beam ID is explicitly provided by being contained in a beacon sequence.

15. The method according to claim 11, wherein the transmitting comprises transmitting the random access channel (RACH) signature with a transmit beam related to the detected beam ID.

16. An apparatus, comprising:
at least one processor; and
at least one memory including computer program code,
the at least one memory and computer program code configured, with the at least one processor, to cause the apparatus at least to
detect a beam ID in the downlink beacon channel;
select a random access channel (RACH) slot using the detected beam ID; and
transmit a random access channel (RACH) signature in one or multiple beam blocks within the random access channel (RACH) slot.

17. The apparatus according to claim 16, wherein the detected beam ID comprises a beam ID of a strongest detected beam.

18. The apparatus according to claim 16, wherein the beam ID is implicitly provided by being associated with a transmission slot.

19. The apparatus according to claim 16, wherein the beam ID is explicitly provided by being contained in a beacon sequence.

20. The apparatus according to claim 16, wherein the at least one memory and the computer program code are further configured, with the at least one processor, to cause the apparatus at least to transmit the random access channel (RACH) signature with a transmit beam related to the detected beam ID.

21. The apparatus according to claim 16, wherein the apparatus comprises a user equipment.

22. A computer program, embodied on a non-transitory computer readable medium, the computer program configured to control a processor to perform a process, comprising:
detecting, by a user equipment, a beam ID in the downlink beacon channel;
selecting a random access channel (RACH) slot using the detected beam ID; and
transmitting, by the user equipment, a random access channel (RACH) signature in one or multiple beam blocks within the random access channel (RACH) slot.
